(19) United States
(12) Patent Application Publication
(10) Pub. No.: US 2024/0335692 A1
(43) Pub. Date: Oct. 10, 2024

(54) DROP PIPE REMOVAL TOOL FOR FIRE SPRINKLER SYSTEMS

(71) Applicant: Adam Summers, Delray Beach, FL (US)

(72) Inventor: Adam Summers, Delray Beach, FL (US)

(21) Appl. No.: 18/628,436

(22) Filed: Apr. 5, 2024

Related U.S. Application Data
(60) Provisional application No. 63/457,158, filed on Apr. 5, 2023.

(51) Int. Cl. A62C 99/00

(52) U.S. Cl. CPC A62C 99/009

(57) ABSTRACT

A tool for tightening and/or loosening a drop pipe in a fire sprinkler system includes a main shaft with a threaded fitting on a distal end for attachment to a reducer coupling on the bottom end of the drop pipe, and a sleeve that partially surrounds the main shaft and is slidably movable relative to the main shaft with a socket fitted to the end of the sleeve for engaging a hex shaped surface on the reducer coupling. A multi-sided flat faced surface on the end of the sleeve allows for removable attachment of the socket thereto in a manner that prevents unwanted rotation of the socket relative to the sleeve when applying torque to the drop pipe. A torque handle extension member removably attaches to a rear end of the sleeve and extends perpendicularly therefrom.

This non-provisional patent application is based on provisional patent application Ser. No. 63/457,158 filed on Apr. 5, 2023.

### BACKGROUND OF THE INVENTION

### Field of the Invention

The present invention relates to tools for use in the installation and repair of fire sprinkler systems, and particularly tools for tightening and/or loosening a drop pipe for removal and attachment of the drop pipe to a main water supply pipe above a ceiling.

### Description of the Related Art

In fire sprinkler systems used in commercial buildings, office buildings, industrial buildings, warehouses and the like, one or more main water supply pipes are installed above the ceilings in the building to provide for water distribution and supply to rooms on each floor of the building. The main water supply pipes each have multiple drop pipes, also referred to as drop nipples, that are connected to the main water supply line, usually by a T-joint coupling. The drop pipe extends vertically down from the horizontal water supply pipe and terminates just above the ceiling. A reducer coupling is fitted to a bottom end of the drop pipe and allows for attachment of a sprinkler head that is preferably flush with the ceiling surface.

There are some instances where it is necessary to remove a drop pipe from the main water supply pipe in a sprinkler system during servicing, such as for maintenance and repairs. However, it is not easy to access the drop pipe through the ceiling, as the hole for the sprinkler head is usually very narrow. Unfortunately, in some instances, it is necessary to cut a larger hole in the ceiling in order to gain access to the drop pipe and remove the drop pipe for repair or replacement. Other times, it may be necessary to adjust the length of a drop pipe for changing the sprinkler head height relative to the ceiling. In any event, accessing the drop pipe and grasping the drop pipe with a tool for removal can be difficult, if not impossible, without damaging the ceiling. Accordingly, there remains a need for a tool that conveniently attaches to the reducer coupling on the bottom end of a drop pipe of a sprinkler system and which engages the reducer coupling in a manner that allows for tightening and loosening of the drop pipe relative to the main water supply line above the ceiling, all without causing any damage to the ceiling or sprinkler system.

### SUMMARY OF THE INVENTION

The present invention is directed to a tool for use in sprinkler systems for loosening a drop pipe in order to remove the drop pipe, and for tightening the drop pipe for installation to a main water supply pipe above a ceiling. The tool includes a main shaft with a threaded fitting on the distal end for removable attachment to a reducer coupling on the bottom end of the drop pipe, thereby allowing for attachment and proper alignment of the tool to the drop pipe. The tool further includes a sleeve that partially surrounds the main shaft and is slidably movable relative to the main shaft and the reducer coupling on the drop pipe when the tool is attached to the reducer coupling. A multi-sided end of the sleeve allows for removable attachment of a socket thereto. The socket is specifically sized and structured for engaging a hex shaped exterior surface on the reducer coupling to allow for application of torque to the reducer coupling and the drop pipe, thereby allowing for tightening and loosening of the drop pipe relative to the main water supply pipe. The multi-sided end of the sleeve, having flat faced surfaces, fits within a congruently sized and shaped receptacle within the socket, allowing for secure attachment of the socket to the end of the sleeve in a manner that prevents rotation of the socket relative to the sleeve when applying significant torque to the reducer coupling and drop pipe during use of the tool.

### BRIEF DESCRIPTION OF THE DRAWINGS

For a fuller understanding of the nature of the present invention, reference should be had to the following detailed description taken in connection with the accompanying drawings in which:

FIG. 1 is a side elevational view showing the fire sprinkler tool of the present invention with a reducer coupling socket removed from an end of the tool to reveal a multi-sided flat faced engaging surface that prevents rotation of the socket relative to the tool when applying torque to a reducer coupling on the bottom end of a drop pipe;

FIG. 2 is a side elevational view of the tool with the socket removed from the end of the tool and a central main shaft extended from an end of the sleeve;

FIG. 3 is an isolated perspective view showing the distal end of the main shaft with a threaded male engagement fitting thereon for threaded attachment to a reducer coupling on a drop pipe of a sprinkler system, and further illustrating the multi-sided flat faced engaging surface on the end of the sleeve of the tool for attached receipt with a socket;

FIG. 4 is a side perspective view showing the socket attached to the end of the sleeve and the male threaded fitting on the end of the shaft engaged within a female threaded surface in the reducer coupling on a drop pipe;

FIG. 5 is an isolated side elevational view showing the male threaded fitting on the end of the shaft of the tool threadably engaged within the female threaded end of the reducer coupling on a drop pipe and the socket on the tool separated from the hexed surface of the reducer coupling;

FIG. 6 is a side elevational view showing the tool of the present invention attached to the reducer coupling on a drop pipe and the socket separated from the reducer coupling, and further showing a set screw on the socket for securing the socket to the multi-sided flat faced attachment surface on the end of the sleeve of the tool;

FIG. 7 is an isolated perspective view showing the male threaded fitting on the end of the shaft secured to the reducer coupling and the socket on the tool separated from the hexed engagement surface of the reducer coupling; and

FIG. 8 is an isolated perspective view showing the socket of the tool fitted over and engaged with the hexed surface of the reducer coupling on the end of the drop pipe for allowing application of torque to the drop pipe of the sprinkler system using the tool in order to tighten or loosen the drop pipe relative to a main water supply line.

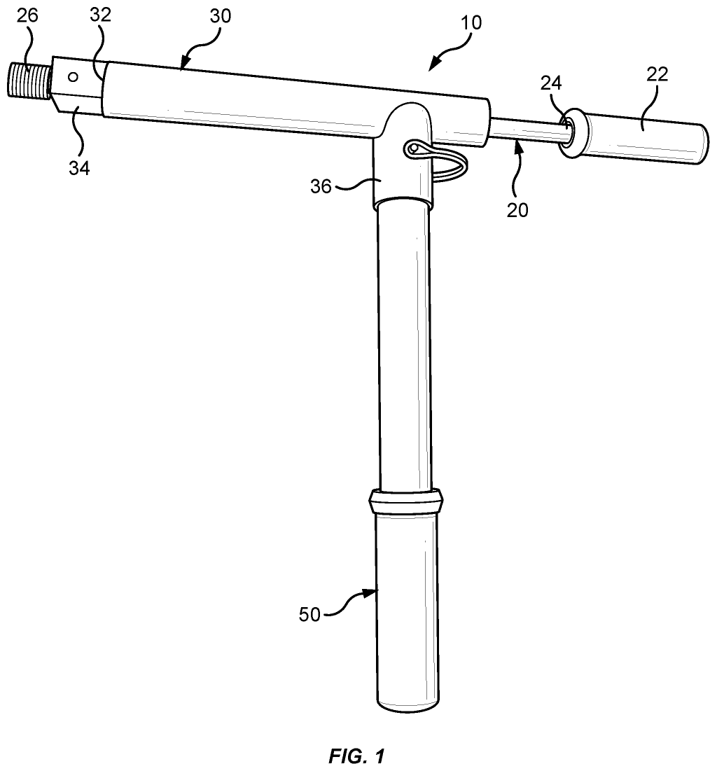

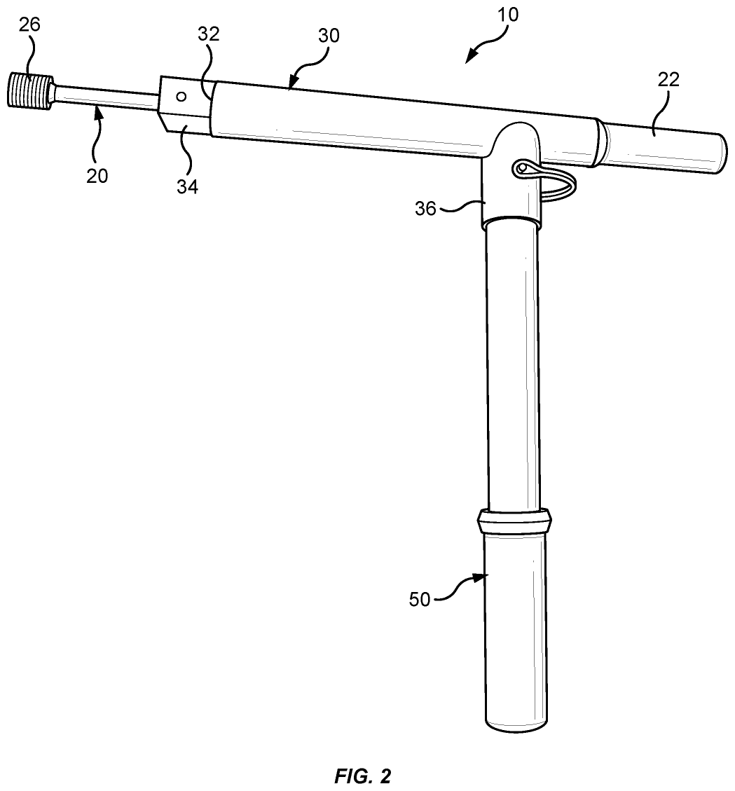

Like reference numerals refer to like parts throughout the several views of the drawings.

### DETAILED DESCRIPTION OF THE PREFERRED EMBODIMENT

Referring to the several views of the drawings, the tool of the present invention is shown and is generally indicated as 10. The tool 10 is for use in sprinkler systems for loosening a drop pipe 100 in order to remove the drop pipe 100 from a main water supply pipe (not shown) above a ceiling. The tool 10 is also used for tightening the attachment of the drop pipe 100 to the main water supply line when installing a repaired, modified or new drop pipe. The tool 10 is specifically structured to engage a reducer coupling 110 on the bottom end 102 of the drop pipe 100. The reducer coupling 110 is specifically designed for installation of a sprinkler head (not shown) thereto. The tool 10 of the present invention includes a main shaft 20 having a handgrip 22 at a proximal end 24 and a male threaded fitting 26 on an opposite distal end 28 that is specifically sized to engage female threads (not shown) within the reducer coupling 110 on the bottom of the drop pipe 100. This allows for attachment of the tool 10 to the drop pipe 100 for purposes of stability and proper alignment, as well as ease of handling the tool 10 without dropping the tool or having to support the entire weight of the tool during use.

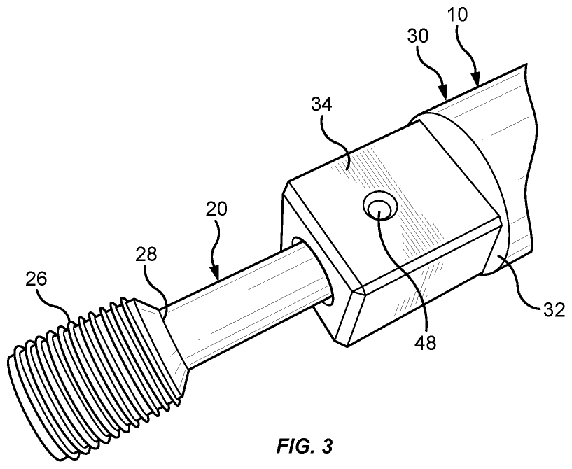

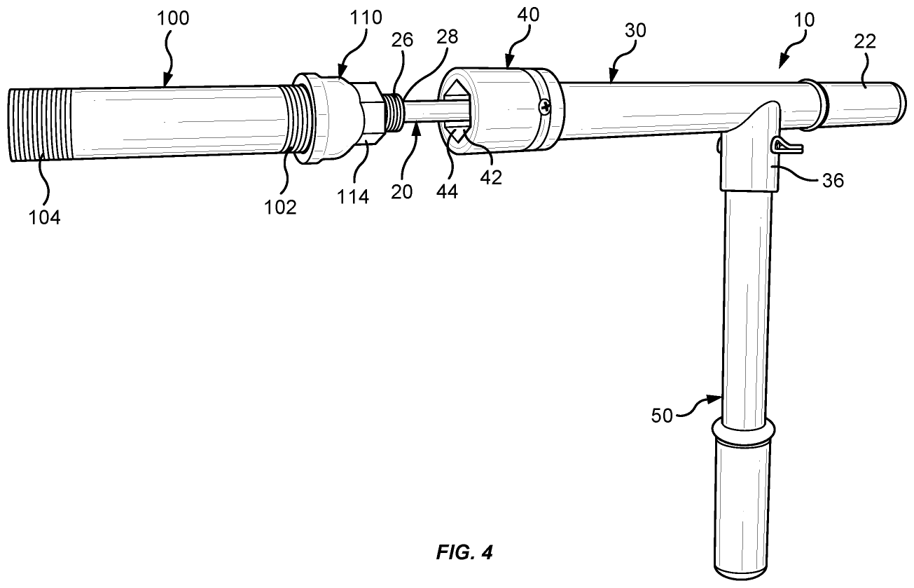

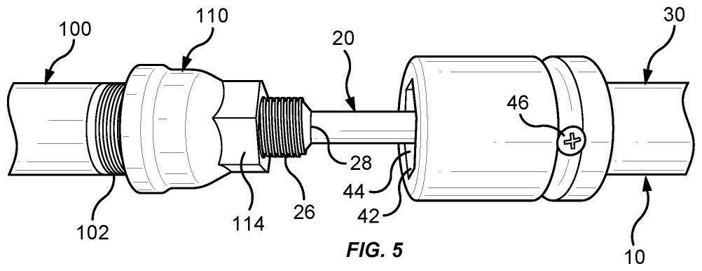

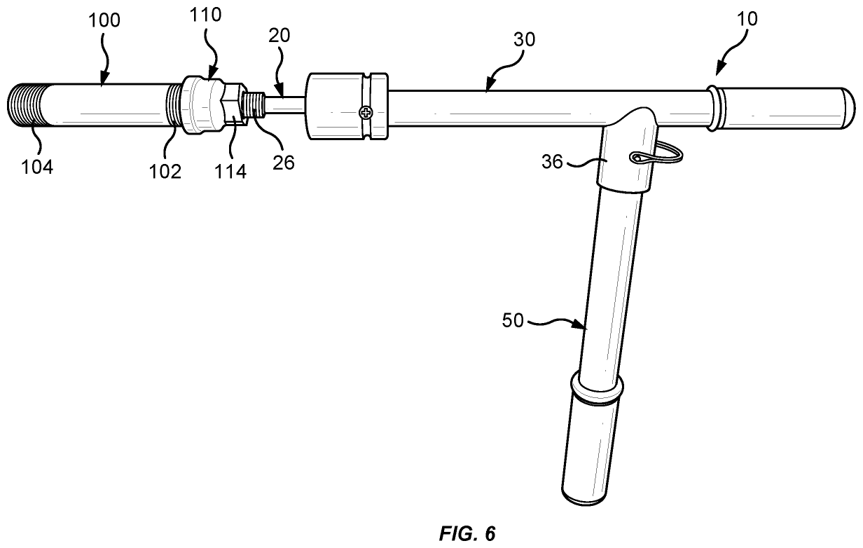

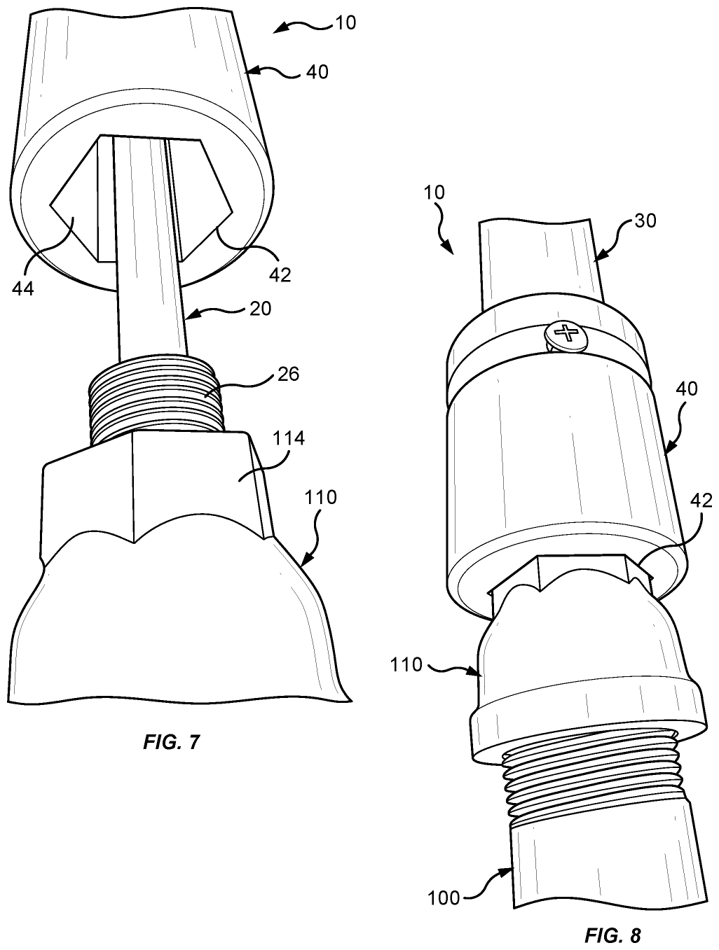

The tool 10 further includes a sleeve 30 that at least partially surrounds the main shaft 20 and is longitudinally movable relative to the main shaft, particularly the distal end 28 with the male threaded fitting 26. The sleeve 30 includes a first end 32, proximal to the distal end 28 of the main shaft 20, that has a four-sided, flat faced attachment member 34 for removable attachment of a socket 40 thereto. The four-sided, flat faced attachment member 34 allows for secure attachment of the socket 40 thereto without rotation of the sleeve 30 relative to the socket 40 when under significant force or torque. Referring to FIG. 5, a set screw 46 secures the socket 40 to the attachment member 34 on the end of the sleeve 30. Referring to FIG. 3, a detent 48 in one of the flat faces of the attachment member 34 is aligned with the set screw 46 so that when the set screw is tightened, the end of the set screw is seated within the detent 48, thereby resisting detachment of the socket 40 from the attachment member 34. The sleeve 30 further includes a torque handle attachment portion 36 for removable attachment of a torque handle extension member 50 that extends generally perpendicular relative to the sleeve 30.

The socket 40 has a female receptacle 42 with a hex shaped multi-faced interior surface 44 that mates with a congruently size and shaped multi-faced exterior surface 114 on the reducer coupling 110. To tighten or loosen the drop pipe 100, the socket 40 on the end of the sleeve 30 of the tool is engaged with the hex shaped multi-faced outer surface 114 of the reducer coupling 110 and torque is applied using the torque handle extension member 50 extending perpendicularly from the sleeve 30, while the tool 10 is attached to the reducer coupling 110 via the male threaded fitting 26 on the distal end 28 of the main shaft 20. It should be noted that the threaded attachment of the upper end 104 of the drop pipe 100 to a T-fitting or other coupling (not shown) on the main water supply line is of less tension than the attachment of the reducer coupling 110 to the bottom end of the drop pipe 100 so that less torque is required to tighten or loosen the drop pipe from the main water supply line as compared to the amount of torque needed to tighten or loosen the reducer coupling 110 on the bottom end of the drop pipe 100. Thus, when torque is applied using the tool 10 of the present invention, the reducer coupling 110 remains securely attached to the bottom end 102 of the drop pipe 100, as the upper end 104 of the drop pipe 100 is tightened or loosened relative to the main water supply line.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A tool for loosening and tightening a drop pipe in a sprinkler system, wherein the drop pipe includes a reducer coupling on a lower end, the tool comprising:
a main shaft having a threaded fitting on a distal end for removable attachment to the reducer coupling on the lower end of the drop pipe, and the main shaft further including a hand grip at an opposite proximal end;
a sleeve at least partially surrounding the main shaft and longitudinally movable relative to the main shaft, and the sleeve including a first end proximal to the distal end of the main shaft, and the first end being movable towards and away from the distal end of the main shaft;
a socket removably attachable to the first end of the sleeve including a female receptacle with a multi-faced interior surface for receipt and mating engagement with a complementary multi-faced exterior surface on the reducer coupling, and the first end of the sleeve and the attached socket being movable in relation to the distal end of the main shaft and the reducer coupling for engaging and disengaging the complementary multi-faced surfaces in the socket and on the reducer coupling, respectively; and
a torque handle extension member attached to the sleeve and extending generally perpendicularly therefrom, and the torque handle extension member being structured and disposed for applying a torque force on the reducer coupling when the multi-faced interior surface of the socket and the multi-faced exterior surface of the reducer coupling are engaged, thereby allowing for removal and installation of the drop pipe to the sprinkler system.

2. The tool as recited in claim 1 further comprising:
the first end of the sleeve including a multi-faced attachment member;
the socket including an attachment receptacle on an opposite end of the socket relative to the female receptacle, and the attachment receptacle including an interior multi-faced surface for congruent receipt and complementary engagement with the multi-faced attachment member on the first end of the sleeve; and
the engagement of the multi-faced attachment member with the multi-faced interior surface of the attachment receptacle in the socket preventing rotation of the socket relative to the sleeve including the first end of the sleeve.

3. The tool as recited in claim 2 further comprising:
a set screw threadably received through a side of the socket and into the attachment receptacle;
a detent in the multi-faced attachment member on the first end of the sleeve for alignment with the set screw; and
an inner end of the set screw being structured and disposed for seated receipt within the detent upon threaded advancement of the set screw through the socket to thereby fixedly attach the socket to the multi-faced attachment member on the first end of the sleeve.

4. The tool as recited in claim 3 wherein the sleeve includes a torque handle attachment member adjacent to a second end of the sleeve for removable attachment of the torque handle extension member to the sleeve.

5. The tool as recited in claim 4 wherein the torque handle attachment member is structured for interlocked, removable attachment of the torque handle extension member to the sleeve.
